(19) United States
(12) Patent Application Publication
(10) Pub. No.: US 2025/0087660 A1
(43) Pub. Date: Mar. 13, 2025

(54) SURFACE MODIFICATION OF CURRENT COLLECTOR PRIOR TO COATING WITH MOLTEN METAL

(71) Applicant: GM GLOBAL TECHNOLOGY OPERATIONS LLC, Detroit, MI (US)

(72) Inventors: Sayed Youssef Sayed NAGY, Troy, MI (US); Diptak Bhattacharya, Royal Oak, MI (US); Caleb Reese, Ferndale, MI (US); Shaomao Xu, Sterling Heights, MI (US); Anil K. Sachdev, Rochester Hills, MI (US)

(21) Appl. No.: 18/462,611

(22) Filed: Sep. 7, 2023

(51) Int. Cl. H01M 4/04; H01M 4/131; H01M 4/134; H01M 4/38; H01M 4/66; H01M 4/74

(52) U.S. Cl. CPC H01M 4/0454; H01M 4/0404; H01M 4/131; H01M 4/134; H01M 4/382; H01M 4/669; H01M 4/74; H01M 2004/021; H01M 2004/027; H01M 4/0426; H01M 4/0428

(57) ABSTRACT

A method for manufacturing an anode electrode for a battery cell includes providing a current collector; and forming a layer on the current collector to create a coated current collector. The layer includes one of a metal and a metal oxide that is not miscible in molten lithium. The method includes immersing the coated current collector in molten lithium to coat the coated current collector.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to current collectors for electrodes of battery cells, and more particularly to a method for coating current collectors of battery cells with metal or metal oxide prior to immersion in molten lithium metal.

Electric vehicles (EVs) such as battery electric vehicles (BEVs), hybrid vehicles, and/or fuel cell vehicles include one or more electric machines and a battery system including one or more battery cells, modules and/or packs. A battery control module is used to control charging and/or discharging of the battery system during charging and/or driving. Manufacturers of EVs are pursuing increased power density to increase the range of the EVs.

### SUMMARY

A method for manufacturing an anode electrode for a battery cell includes providing a current collector; and forming a layer on the current collector to create a coated current collector. The layer includes one of a metal and a metal oxide that is not miscible in molten lithium. The method includes immersing the coated current collector in molten lithium to coat the coated current collector.

In other features, the current collector comprises a mesh current collector. The current collector is made of a material selected from a group consisting of copper (Cu), stainless steel (SS), nickel (Ni), and alloys thereof. The current collector includes a plurality of first wires and a plurality of second wires overlapping and arranged at an angle relative to the plurality of first wires. The plurality of first wires and the plurality of second wires have a thickness in a range from 4 μm to 100 μm thick. The current collector includes 100 to 300 openings per square inch between the plurality of first wires and the plurality of second wires. The one of the metal and the metal oxide is selected from a group consisting of zinc (Zn), nickel (Ni), bismuth (Bi), tin (Sn) and germanium (Ge). The one of the metal and the metal oxide is selected from a group consisting of zinc (Zn) oxide, nickel (Ni) oxide, bismuth (Bi) oxide, tin (Sn) oxide, and germanium (Ge) oxide.

In other features, the layer is electrochemically deposited on the current collector. The layer is vacuum deposited on the current collector. The layer is sputtered onto the current collector. The layer is laser deposited onto the current collector. The layer has a thickness in a range from 5 nm to 200 nm.

A method for manufacturing an anode electrode, comprises providing a mesh current collector made of a material selected from a group consisting of copper, stainless steel, and nickel; and forming a layer on the mesh current collector to create a coated mesh current collector. The layer includes one of metal and metal oxide that is selected from a group consisting of nickel (Ni), zinc (Zn), bismuth (Bi), tin (Sn), germanium (Ge), and oxides thereof and has a thickness in a range from 5 nm to 200 nm. The method includes immersing the coated mesh current collector in molten lithium to coat the coated mesh current collector.

In other features, the mesh current collector includes a plurality of first wires and a plurality of second wires arranged at an angle relative to the plurality of first wires. The plurality of first wires and the plurality of second wires have a thickness in a range from 4 μm to 100 μm thick. The mesh current collector includes 100 to 300 openings per square inch between the plurality of first wires and the plurality of second wires.

In other features, one of the layer is electrochemically deposited on the mesh current collector, the layer is vacuum deposited on the mesh current collector, the layer is sputtered onto the mesh current collector, and the layer is laser deposited on the mesh current collector.

An anode electrode for a battery cell includes a mesh current collector made of a material selected from a group consisting of copper, stainless steel, and nickel. A layer is arranged on the mesh current collector. The layer includes one of metal and metal oxide that is selected from a group consisting of nickel (Ni), zinc (Zn), bismuth (Bi), tin (Sn), germanium (Ge), and oxides thereof and has a thickness in a range from 5 nm to 200 nm. A lithium layer formed from molten lithium coats the layer.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a cross sectional view of an example of a battery cell including anode electrodes, cathode electrodes, and separators according to the present disclosure;

FIGS. 2A and 2B are plan views illustrating an example of a copper current collector after immersion in molten lithium;

FIG. 2C is a plan view illustrating an example of a coated copper current collector after immersion in molten lithium according to the present disclosure;

FIG. 3 is an example of a binary phase diagram for lithium and copper;

FIGS. 4A and 4B illustrate an example of intergranular attack during immersion of a copper current collector in molten lithium;

FIGS. 5 and 6 are enlarged views showing an example of grain boundaries of copper that are dissolved in molten lithium when the uncoated current collector is used;

FIG. 7A illustrates an example of electrochemical coating of the current collector with a metal or metal oxide layer than is not miscible in molten lithium according to the present disclosure;

FIG. 7B illustrates an example of immersion of the coated mesh current collector in molten lithium to form a lithium anode electrode according to the present disclosure;

FIG. 8 is an example of a method for manufacturing coated mesh current collectors that are immersed in molten lithium to form a lithium anode electrode of a battery cell according to the present disclosure; and

FIG. 9 illustrates an example of a coated mesh current collector after immersion in molten lithium according to the present disclosure.

In the drawings, reference numbers may be reused to identify similar and/or identical elements.

### DETAILED DESCRIPTION

While the battery cells and/or electrodes according to the present disclosure are described herein in the context of electric vehicles, the battery cells and/or electrodes can be used in stationary applications and/or in other types of applications.

Battery cells include anode electrodes, cathode electrodes, and separators arranged in a predetermined order in an enclosure. The anode electrodes include an anode active layer arranged on one or both sides of an anode current collector. The cathode electrodes include a cathode active layer arranged on one or both sides of a cathode current collector.

In some examples, the anode and cathode current collectors include wire mesh, foil, or expanded metal. For example, mesh current collectors include overlapping wires that are arranged at an angle and that are made of copper, stainless steel, nickel, and alloys thereof. The wire mesh current collector may be fabricated with wires that are 4 μm to 100 μm thick (e.g., 30 μm). In some examples, the wire mesh current collector has about 100 to 300 openings per square inch (e.g., 100).

The present disclosure relates to methods for coating the current collector (e.g., a copper mesh current collector) with lithium molten metal (e.g., lithium or lithium alloy). For example, when copper-based mesh current collectors are immersed in molten lithium, some of the copper in the copper mesh current collector dissolves in the molten lithium due to a dissolution-assisted (intergranular) corrosion reaction between the molten lithium and the copper. The dissolution causes disintegration of portions of the wires of the mesh current collector. In addition, the molten lithium bath is contaminated by the dissolved copper, which adversely affects the density of the lithium anodes electrodes made using the contaminated molten lithium bath.

Prior to immersing the current collector in molten lithium bath, the current collector is coated with a metal or metal oxide with no miscibility to molten lithium. For example, the metal or metal oxide layer can comprise a material selected from a group consisting of tin (Sn), zinc (Zn), nickel (Ni), bismuth (Bi), germanium (Ge), and their oxides. The metal or metal oxide layer prevents intergranular attack of the base metal of the current collector (e.g., copper).

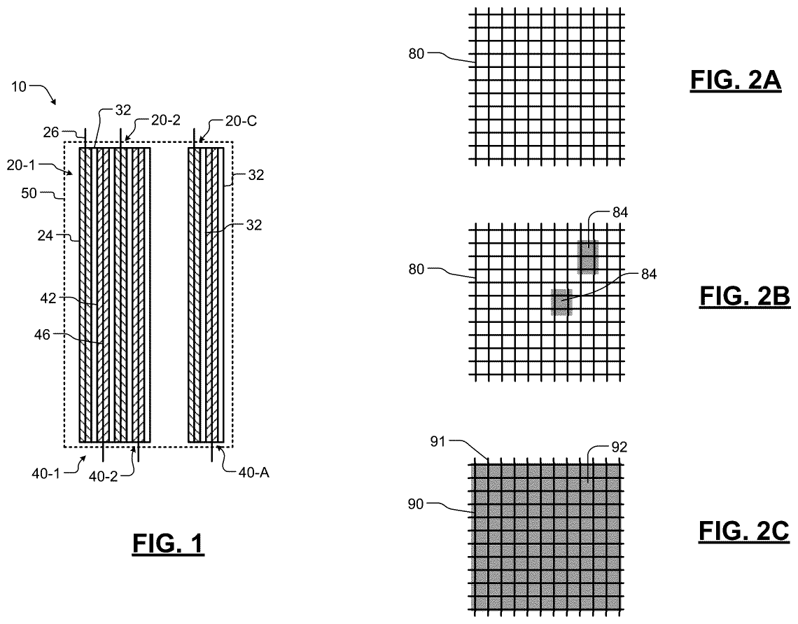

Referring now to FIG. 1, a battery cell 10 includes cathode electrodes 20-1, 20-2, . . . , and 20-C, where C is an integer greater than one. The cathode electrodes 20 include a cathode active material layer 24 arranged on one or both sides of cathode current collectors 26. The battery cell 10 includes anode electrodes 40-1, 40-2, . . . , and 40-A, where A is an integer greater than one. The anode electrodes 40 include an anode active material layer 42 arranged on one or both sides of anode current collectors 46. The cathode electrodes 20, the anode electrodes 40 and the separators 32 are arranged in a predetermined order in an enclosure 50. For example, separators 32 are arranged between the cathode electrodes 20 and the anode electrodes 40.

Referring now to FIGS. 2A to 2C, an example of dissolution of the base metal of the current collector when immersed in lithium metal is shown. In this example, the current collector includes a copper current collector 80 including a wire mesh. In FIGS. 2A and 2B, the copper current collector 80 is uncoated before immersion in the molten lithium. As can be seen in FIG. 2B, limited lithium wetting of the copper current collector 80 occurs at 84 and the copper of the copper wire mesh dissolves in the molten lithium due to a dissolution-assisted (intergranular) corrosion reaction between the molten lithium and the copper.

In FIG. 2C, a current collector 90 comprises a copper wire mesh that includes an outer layer 91 arranged on the current collector. The outer layer 91 includes a metal or metal oxide species that has no miscibility in molten lithium. Miscibility is the property of two substances to mix and form a homogeneous mixture.

For example, the outer layer 91 may include a material selected from a group consisting of tin (Sn), zinc (Zn), nickel (Ni), bismuth (Bi), germanium (Ge), and their oxides. The outer layer 91 can be applied using any suitable process such as electrochemical deposition, vacuum deposition, sputtering, laser deposition, or other methods. When the current collector 90 with the outer layer 91 is immersed in molten lithium 92, the molten lithium 92 does not dissolve the base metal of the current collector. The molten lithium 92 is able to infiltrate gaps between wires of the current collector 90 and wetting of the current collector 90 improves.

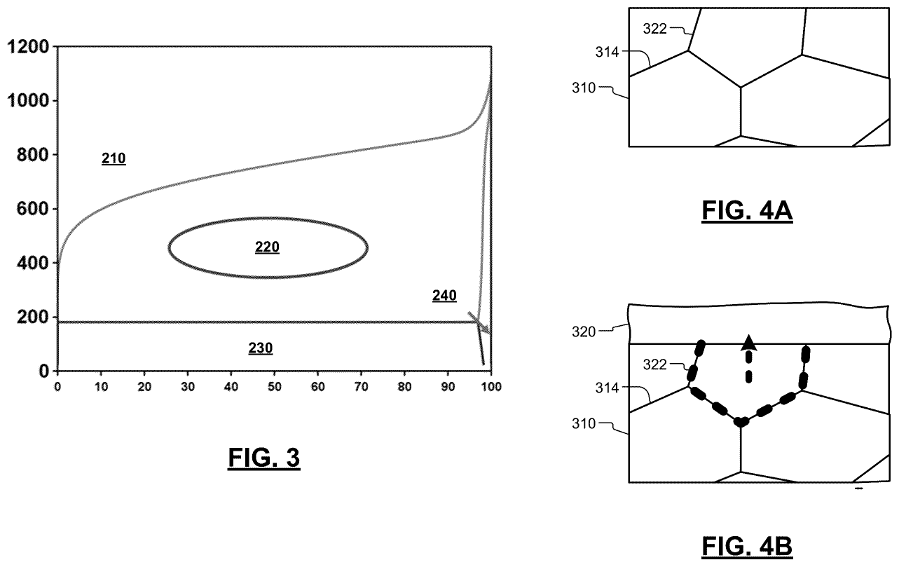

Referring now to FIG. 3, a graph illustrates lithium and copper binary phases. A liquid phase of lithium is shown at 210, a liquid and solid copper phase at 220, a solid lithium and copper phase at 230, and a solid copper phase at 240. The Li—Cu binary phase diagram indicates limited (near zero) mutual solubility between Li and Cu. Note that there are no intermetallic phases in the Li—Cu system. When liquid Li is in contact with the Cu, a two-phase equilibria is set up and a portion of the Cu is replaced by Li-rich liquid. Since liquid Li has no intermetallic reaction with Cu, Li-rich liquid has direct access to the grain boundaries in the Cu substrate, which provides a pathway for intergranular attack. Liquid tin (Sn), on the other hand, behaves differently since it would dissolve Cu and make intermetallic phases between two elements.

Referring now to FIGS. 4A and 4B, a dissolution-assisted (intergranular) corrosion reaction is shown. In FIG. 4A, copper 310 (e.g., the base metal of the current collector in some examples) includes grain boundaries 314 and 322. In FIG. 4B, when copper 310 is immersed in molten lithium 320, intergranular attack occurs. The molten lithium 320 infiltrates the grain boundary 322 and eventually causes partial dissolution of the copper 310.

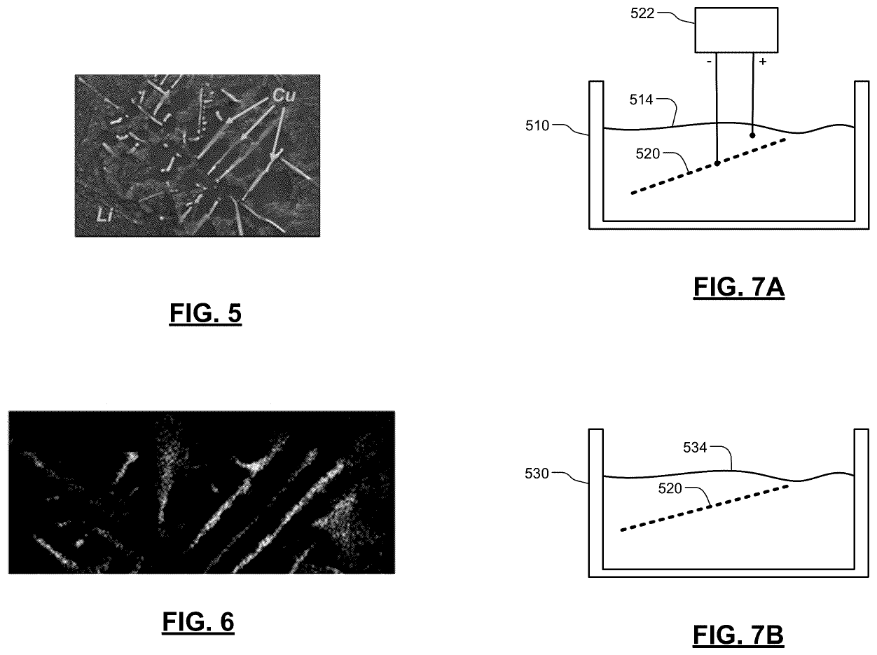

Referring now to FIGS. 5 and 6, molten lithium enters the grain boundaries and dissolves some of the copper. The molten lithium-copper alloy solidifies at the grain boundary, which weakens the grain boundary. Some of the Cu grains have weakened intergranular attachment and separate from the rest of the Cu substrate (e.g., the copper mesh) resulting in decrepitation of the Cu. The dissolved copper in the molten Li will precipitate out upon solidification leading to contamination of the lithium. FIGS. 5 and 6 show copper precipitation into the molten lithium.

To eliminate dissolution of the base metal (e.g., Cu) of the current collector when immersed in molten lithium, an outer layer of metal or metal oxide is coated on the current collector. The metal or metal oxide species has no miscibility in molten lithium. For example, the layer may include tin (Sn), zinc (Zn), nickel (Ni), bismuth (Bi), germanium (Ge), and their oxides.

The outer layer can be applied to the current collector (prior to immersion in the molten lithium) using any suitable process (e.g., electrochemical deposition, vacuum deposition, sputtering, laser deposition, or other deposition methods). In some examples, the metal or metal oxide layer is deposited on the current collector using electron beam evaporation and/or vacuum thermal evaporation. In some examples, the metal or metal oxide layer is deposited on the current collector using chemical vapor deposition (CVD) and/or physical vapor deposition (PVD). In some examples, the metal or metal oxide layer is deposited on the current collector using atomic layer deposition (ALD), molecular beam epitaxy (MBE), and/or arc evaporation. In some examples, the metal or metal oxide layer is deposited on the current collector using sputtering methods (e.g., DC and RF sputtering, DC magnetron sputtering, and/or reactive sputtering). In some examples, the metal and/or metal oxide layer is deposited on the current collector using laser deposition techniques such as pulsed laser deposition.

Referring now to FIGS. 7A and 7B, an example of manufacturing of the current collector using electrochemical deposition is shown. Initially, electrodeposition of the metal or metal oxide layer is performed on the current collector in a bath. Subsequently, the current collector with the metal or metal oxide layer is immersed in molten lithium in another bath.

In FIG. 7A, a current collector 520 (e.g., copper mesh current collector) is connected to a negative terminal of a power supply 522 and immersed in a bath 510 including a salt of a molten metal or molten metal oxide 514. The bath 510 (or the salt of molten metal or molten metal oxide 514) is connected to the positive terminal of the power supply 522. The power supply 522 creates a voltage difference that causes electrodeposition of the metal or metal oxide onto an outer surface of the current collector 520 and creates a layer. When the layer has a sufficient thickness (typically proportional to plating time), the current collector 520 is removed from the bath 510 (and includes the metal or metal oxide layer). In some examples, the metal or metal oxide layer has a thickness in a range from 5 nm to 200 nm, although other thicknesses can be used. In some examples, the current collector is coated for a period in a range from 15 seconds to 2 minutes, although other coating periods can be used.

In FIG. 7B, after deposition of the layer, the current collector 520 with the metal or metal oxide layer is immersed in a bath 530 including molten lithium 534. The molten lithium 534 coats the current collector 520 without dissolving the base metal (e.g., Cu) of the current collector 520.

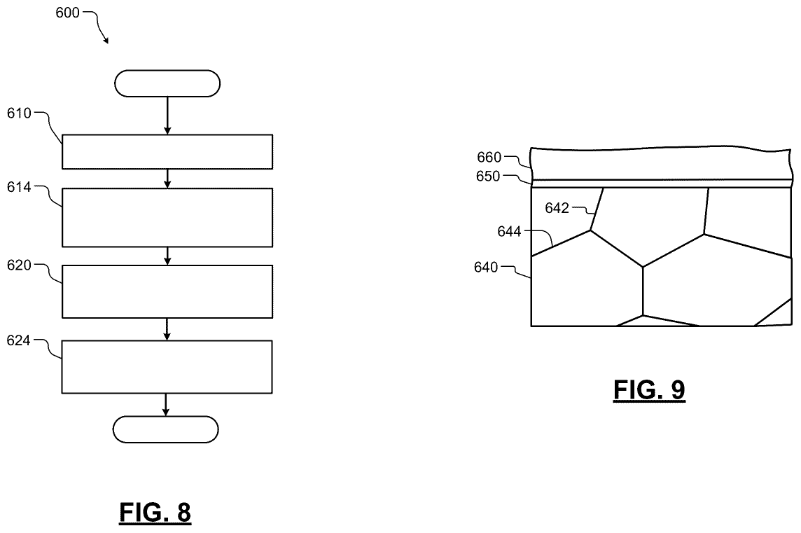

In FIG. 8, a method 600 for manufacturing a coated mesh current collector, a lithium anode electrode, and/or a battery cell is shown. At 610, a current collector is provided. At 614, a layer of metal or metal oxide is deposited on the current collector 614 using any suitable method (e.g., electrochemical deposition or other methods). Once the layer is coated on the current collector, the current collector is immersed in molten lithium at 620 to create a lithium anode electrode. At 624, the lithium coated anode is arranged in the battery cell stack.

In FIG. 9, a metal or metal oxide layer 650 is shown on an outer surface of a base metal of a current collector 640 (e.g., a copper mesh current collector). The metal or metal oxide layer 650 acts as a barrier to a molten lithium layer 660 and prevents intergranular attack in grain boundaries 642 and 644. By introducing a metal/metal oxide coating between the lithium and copper, dissolution in grain boundaries of the copper current collector is avoided. This allows the energy density of the lithium anodes to be unaffected by the copper.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

What is claimed is:

1. A method for manufacturing an anode electrode for a battery cell, comprising:
providing a current collector;
forming a layer on the current collector to create a coated current collector,
wherein the layer includes one of a metal and a metal oxide that is not miscible in molten lithium; and
immersing the coated current collector in molten lithium to coat the coated current collector.

2. The method of claim 1, wherein the current collector comprises a mesh current collector.

3. The method of claim 1, wherein the current collector is made of a material selected from a group consisting of copper (Cu), stainless steel (SS), nickel (Ni), and alloys thereof.

4. The method of claim 2, wherein the current collector includes a plurality of first wires and a plurality of second wires overlapping and arranged at an angle relative to the plurality of first wires.

5. The method of claim 4, wherein the plurality of first wires and the plurality of second wires have a thickness in a range from 4 μm to 100 μm thick.

6. The method of claim 4, wherein the current collector includes 100 to 300 openings per square inch between the plurality of first wires and the plurality of second wires.

7. The method of claim 1, wherein the one of the metal and the metal oxide is selected from a group consisting of zinc (Zn), nickel (Ni), bismuth (Bi), tin (Sn) and germanium (Ge).

8. The method of claim 1, wherein the one of the metal and the metal oxide is selected from a group consisting of zinc (Zn) oxide, nickel (Ni) oxide, bismuth (Bi) oxide, tin (Sn) oxide, and germanium (Ge) oxide.

9. The method of claim 1, wherein the layer is electrochemically deposited on the current collector.

10. The method of claim 1, wherein the layer is vacuum deposited on the current collector.

11. The method of claim 1, wherein the layer is sputtered onto the current collector.

12. The method of claim 1, wherein the layer is laser deposited onto the current collector.

13. The method of claim 1, wherein the layer has a thickness in a range from 5 nm to 200 nm.

14. A method for manufacturing an anode electrode, comprising:
providing a mesh current collector made of a material selected from a group consisting of copper, stainless steel, and nickel;
forming a layer on the mesh current collector to create a coated mesh current collector,
wherein the layer includes one of metal and metal oxide that is selected from a group consisting of nickel (Ni), zinc (Zn), bismuth (Bi), tin (Sn), germanium (Ge), and oxides thereof and has a thickness in a range from 5 nm to 200 nm; and
immersing the coated mesh current collector in molten lithium to coat the coated mesh current collector.

15. The method of claim 14, wherein the mesh current collector includes a plurality of first wires and a plurality of second wires arranged at an angle relative to the plurality of first wires.

16. The method of claim 15, wherein the plurality of first wires and the plurality of second wires have a thickness in a range from 4 μm to 100 μm thick.

17. The method of claim 15, wherein the mesh current collector includes 100 to 300 openings per square inch between the plurality of first wires and the plurality of second wires.

18. The method of claim 14, wherein one of:
the layer is electrochemically deposited on the mesh current collector,
the layer is vacuum deposited on the mesh current collector,
the layer is sputtered onto the mesh current collector, and
the layer is laser deposited on the mesh current collector.

19. An anode electrode for a battery cell, comprising:
a mesh current collector made of a material selected from a group consisting of copper, stainless steel, and nickel;
a layer arranged on the mesh current collector,
wherein the layer includes one of metal and metal oxide that is selected from a group consisting of nickel (Ni), zinc (Zn), bismuth (Bi), tin (Sn), germanium (Ge), and oxides thereof and has a thickness in a range from 5 nm to 200 nm; and
a lithium layer formed from molten lithium coating the layer.
